(19) United States
(12) Patent Application Publication
(10) Pub. No.: US 2025/0037933 A1
(43) Pub. Date: Jan. 30, 2025

(54) METHOD FOR PRODUCING RARE EARTH IRON-BASED SINTERED MAGNET, APPARATUS FOR PRODUCING RARE EARTH IRON-BASED SINTERED MAGNET, AND RARE EARTH IRON-BASED SINTERED MAGNET

(71) Applicant: MINEBEA MITSUMI Inc., Nagano (JP)

(72) Inventors: Yu OKAWARA, Kitasaku-gun (JP); Haruhiro KOMURA, Kitasaku-gun (JP); Yuki ITO, Kitasaku-gun (JP); Heki NAKAYA, Kitasaku-gun (JP)

(21) Appl. No.: 18/717,056

(22) PCT Filed: Nov. 4, 2022
(86) PCT No.: PCT/JP2022/041197

§ 371 Date: Jun. 6, 2024

(30) Foreign Application Priority Data
Dec. 7, 2021 (JP) 2021-198596

(51) Int. Cl. H01F 41/02; H01F 1/057; H01F 13/00

(52) U.S. Cl. CPC H01F 41/0266; H01F 1/0577; H01F 13/003

(57) ABSTRACT

A method of producing a rare earth iron-based sintered magnet according to an embodiment includes a step of filling a mold with a rare earth iron-based magnet powder produced by a rapid quenching method, a step of setting the mold in a sintering apparatus, supplying a predetermined current from electrodes, and pressurizing and heating the rare earth iron-based magnet powder filled to produce a sintered magnet body, and a step of magnetizing the sintered magnet body with a magnetizing device. The mold includes dies having a hollow cylindrical form, punches to be inserted into the dies, and die supports made of a conductive material and respectively disposed at both ends of the dies in an axial direction. A cavity to be formed by the dies and the punches is filled with the rare earth iron-based magnet powder. The dies include an inner die made of a non-conductive material and an outer die made of a conductive material and disposed outside the inner die, inner peripheral surfaces of the die supports are in contact with an outer peripheral surface of the outer die, and the electrodes are in contact with the die supports.

### CROSS REFERENCE TO RELATED APPLICATIONS

This application is a national stage entry of International Application No. PCT/2022/041197 filed on Nov. 4, 2022, which claims priority to Japanese Patent Application 2021-198596, filed on Dec. 7, 2021, which are incorporated herein by reference.

### TECHNICAL FIELD

The disclosure relates to a method for producing a rare earth iron-based sintered magnet, an apparatus for producing a rare earth iron-based sintered magnet, and a rare earth iron-based sintered magnet.

### BACKGROUND

As devices become smaller and achieve higher performance, rare earth permanent magnets having high magnetic characteristics are increasingly being used as magnets for motors in the devices. In addition, in recent years, the demand for motors for in-vehicle applications has increased, and heat resistance and environmental resistance have been required.

A magnet formed by mixing a magnet powder and a resin (so-called bonded magnet) serves as a common motor magnet. Although bonded magnets have a degree of freedom in molding, it is difficult to use the bonded magnets in a high-temperature environment such as an engine compartment because the resin, being an organic material, is used as a binder.

On the other hand, there is a technique involving an alloy thin piece, prepared from a rare earth-iron-based alloy in a molten state, being made to fill a cavity constituted by punches serving as a pair of electrodes and dies, and the production of a rare earth iron-based permanent magnet by spark plasma sintering without using a binder (for example, see JP 4-96203 A). In the production method described in JP 4-96203 A, the punches serving as a pair of electrodes are made of a conductive cemented carbide, and the dies are made of non-conductive SiAlON.

Since the rare earth iron-based permanent magnet described in JP 4-96203 A is produced by spark plasma sintering without using a resin binder, it can be used even in a high-temperature environment. In addition, based on the density ratio between the rare earth iron-based magnet powder (Nd—Fe—B-based magnet powder) and the bonded magnet composed of a resin, the rare earth iron-based permanent magnet described in JP 4-96203 A is expected to have improved magnetic characteristics 20% better than a bonded magnet.

### SUMMARY

The rare earth iron-based permanent magnet produced as described above was then magnetized. However, the measurement result of the surface magnetic flux density after the magnetization showed that, compared with a bonded magnet, the improvement was about 6%; far short of the expected improvement of about 20%.

For this reason, the present inventors observed the interface of the magnet powders of the rare earth iron-based permanent magnet with an electron microscope, and as a result of intensive studies, found that there were locations where the interface between the magnet powders in contact with each other was unclear, and the magnet powders were found to be welded to each other at those locations, appearing as coarse grains. It is considered the magnetic characteristics deteriorated due to the coarse grains. In particular, when the permanent magnet is small, the ratio of the size of the coarse grains becomes relatively large, and it is considered the influence on the magnetic characteristics increases by a corresponding amount.

The disclosure has been made in view of the above circumstances, and an object of the disclosure is to provide a method for producing a rare earth iron-based sintered magnet, an apparatus for producing a rare earth iron-based sintered magnet, and a rare earth iron-based sintered magnet capable of suppressing coarse grains generated at an interface between rare earth iron-based permanent magnet powders and improving magnetic characteristics.

A method of producing a rare earth iron-based sintered magnet according to an aspect of the disclosure includes: filling a mold with a rare earth iron-based magnet powder produced by a rapid quenching method; setting the mold in a sintering apparatus, supplying a predetermined current from electrodes, and pressurizing and heating the rare earth iron-based magnet powder filled to produce a sintered magnet body; and magnetizing the sintered magnet body with a magnetizing device. The mold includes dies having a hollow cylindrical form, punches to be inserted into the dies, and die supports made of a conductive material and disposed at respective both ends of the dies in an axial direction. The cavity to be formed by the dies and the punches is filled with the rare earth iron-based magnet powder. The dies include an inner die made of a non-conductive material and an outer die made of a conductive material and disposed outside the inner die, inner peripheral surfaces of the die supports are in contact with an outer peripheral surface of the outer die, and the electrodes are in contact with the die supports.

The method for producing a rare earth iron-based sintered magnet according to an aspect of the disclosure can suppress the formation of coarse grains at the interface between the rare earth iron-based permanent magnet powders and improve magnetic characteristics.

### BRIEF DESCRIPTION OF DRAWINGS

FIG. 1 is a flowchart illustrating an example of steps of a method of producing a rare earth iron-based sintered magnet according to an embodiment.

FIG. 2 is a cross-sectional view illustrating a state in which a mold is filled with a rare earth iron-based (Nd—Fe—B-based) magnet powder serving as a magnet powder and an upper punch is set.

FIG. 3 is a cross-sectional view illustrating a state in which an upper insulating plate and an upper die support are set on an upper punch.

FIG. 4 is a cross-sectional view illustrating a state in which a mold is set in a sintering apparatus.

FIG. 5 is a perspective view of a sintered magnet body.

FIG. 6 is a view showing examples of measurement results of surface magnetic flux densities of a bonded magnet, a sintered magnet produced by a conventional production method, and a sintered magnet produced by the production method of the embodiment.

FIG. 7 shows the crystal structures of a sintered magnet according to a conventional production method and a sintered magnet according to the production method of the embodiment observed by using an electron microscope.

### DESCRIPTION OF EMBODIMENTS

A method for producing a rare earth iron-based sintered magnet, an apparatus for producing a rare earth iron-based sintered magnet, and a rare earth iron-based sintered magnet according to an embodiment will be described with reference to the accompanying drawings. Note that the disclosure is not limited to the embodiment. Furthermore, the dimensional relationships between elements, proportions of the elements, and the like in the drawings may differ from reality. The drawings may include parts having mutually different dimensional relationships and scales. Furthermore, the contents described in one embodiment or modification example are applied in principle to other embodiments or modification examples.

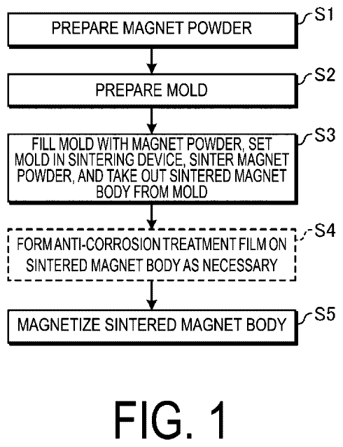

FIG. 1 is a flowchart illustrating an example of steps of a method for producing a rare earth iron-based sintered magnet according to an embodiment. Note that the following steps of the production method are performed manually by an operator, by a robot mechanism or the like operated under the control of a control device (computer device), or by a combination of both.

In FIG. 1, an operator or a control device first prepares a magnet powder (step S1). Here, the rare earth iron-based magnet is an R-T-B (boron)-based magnet as follows. The R-T-B-based magnet includes an R₂T₁₄B phase (for example, a Nd₂Fe₁₄B-based compound phase) being a ternary tetragonal compound as a main phase. The R-T-B-based magnet usually further includes an R-rich phase or the like. R represents a rare earth element including Nd and/or Pr. In other words, R contains Nd and/or Pr as essential components. Examples of rare earth elements other than Nd and praseodymium (Pr) include scandium (Sc), yttrium (Y), lanthanum (La), cerium (Ce), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). Rare earth elements other than Nd and Pr may be used alone or in a combination of two or more. Specifically, as R, only Nd may be used, only Pr may be used, or only Nd and Pr may be used. In addition, Nd and a rare earth element other than Nd and Pr may be used, Pr and a rare earth clement other than Nd and Pr may be used, or Nd and Pr and a rare earth clement other than Nd and Pr may be used. As R, at least Nd is preferably used. T represents Fe, or Fe and Co. As described above, T may be only Fc or may be partially substituted with Co. When the total amount of T is taken as 100 atomic %, Fe is preferably contained in an amount of 50 atomic % or more.

The R-T-B-based magnet may contain other elements. Examples of the other elements include titanium (Ti), zirconium (Zr), niobium (Nb), molybdenum (Mo), hafnium (Hf), tantalum (Ta), and tungsten (W). The other elements may be used alone or in a combination of two or more. In the R-T-B-based magnet, R is preferably contained in an amount of 12 atomic % or more and 16 atomic % or less. B is preferably contained in an amount of 6 atomic % or more and 8 atomic % or less. When the other elements described above are contained, the other elements are preferably contained in an amount of more than 0 atomic % and 3 atomic % or less in total. Here, the balance is the total amount of T and inevitably contained elements.

Here, as the R-T-B-based magnet, for example, a Nd—Fe—B-based magnet using a Nd—Fe—B-based alloy having Nd₂Fe₁₄B as a main phase is used as an example, and a rare earth iron-based magnet powder for that purpose is used.

The operator or the control device produces the rare earth iron-based magnet powder by, for example, a rapid quenching method (melt span method). Specifically, the operator or the control device melts the Nd—Fe—B-based alloy by high-frequency induction heating under reduced pressure or in an argon atmosphere. Next, the molten metal of the molten alloy is sprayed onto a rotating roll and is rapidly quenched (rapidly cooled) to produce a ribbon-like thin strip. The thin strip is then crushed. For example, it is preferable that the thin strip be broken into pieces of about several mm to several tens of mm and then crushed by a crusher or the like. The thin strip is crushed to obtain a crushed powder.

Next, after the ribbon-shaped thin strip has been crushed to obtain a powder, the operator or the control device performs a heat treatment on the powder to obtain a rare earth iron-based magnet powder. At this stage, since the directions of the axes of casy magnetization of the crystal grains of the powder are not aligned in one direction, the powder is magnetically isotropic. Instead of the actual production of the rare earth iron-based magnet powder, a previously produced rare earth iron-based magnet powder can be used. For example, a magnetically isotropic Nd—Fe—B-based rare earth iron-based magnet powder produced by a rapid quenching method and crushed is provided by Magnequench.

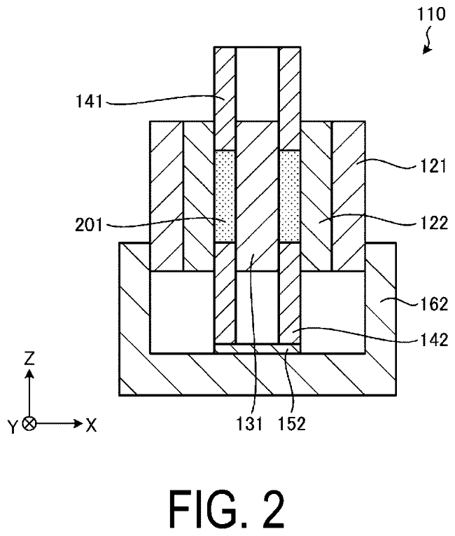

Next, the operator or the control device prepares the mold 110 (step S2). As illustrated in FIGS. 2 to 4, the mold 110 includes an outer die 121 and an inner die 122, the outer die 121 and the inner die 122 having a hollow cylindrical form; an upper punch 141 and a lower punch 142, the upper punch 141 and the lower punch 142 having a cylindrical form and being inserted into the inner die 122; and a core 131, the core 131 having a cylindrical form and being inserted into the upper punch 141 and the lower punch 142. In addition, the mold 110 includes an upper die support 161 and a lower die support 162 fitted to the outside of the outer die 121 and has a hollow cylindrical form with one end closed. An upper insulating plate 151 is interposed between the upper punch 141 and the upper die support 161, and a lower insulating plate 152 is interposed between the lower punch 142 and the lower die support 162. Both the upper insulating plate 151 and the lower insulating plate 152 are disc-shaped.

The upper punch 141, the lower punch 142, and the core 131 are made of conductive cemented carbide, the outer die 121 is made of a conductive material (for example, graphite, cemented carbide, or the like), and the inner die 122 is made of a non-conductive material (for example, silicon nitride, SiAlON, or the like). The upper die support 161 and the lower die support 162 are made of a conductive material (for example, graphite, cemented carbide, or the like), and the upper insulating plate 151 and the lower insulating plate 152 are made of a non-conductive material (for example, a boron nitride sheet, a silicon nitride plate, or the like having electrical insulating properties and heat resistance).

Next, referring back to FIG. 1, the operator or the control device fills the mold 110 with the magnet powder, sets the mold 110 in the sintering apparatus 100 for sintering, and takes out the sintered magnet body from the mold 110 (step S3).

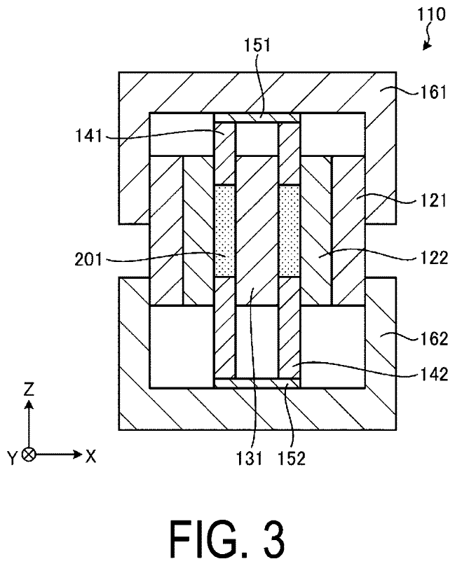

FIG. 2 is a cross-sectional view illustrating a state in which a rare earth iron-based (Nd—Fe—B-based) magnet powder 201 as a magnet powder is filled in a mold 110 and an upper punch 141 is set. That is, FIG. 2 illustrates a cavity formed by the upper punch 141, the lower punch 142, the inner die 122, and the core 131 filled with the rare earth iron-based (Nd—Fe—B-based) magnet powder 201. FIG. 3 is a cross-sectional view illustrating a state in which the upper insulating plate 151 and the upper die support 161 are set on the upper punch 141 from the state illustrated in FIG. 2.

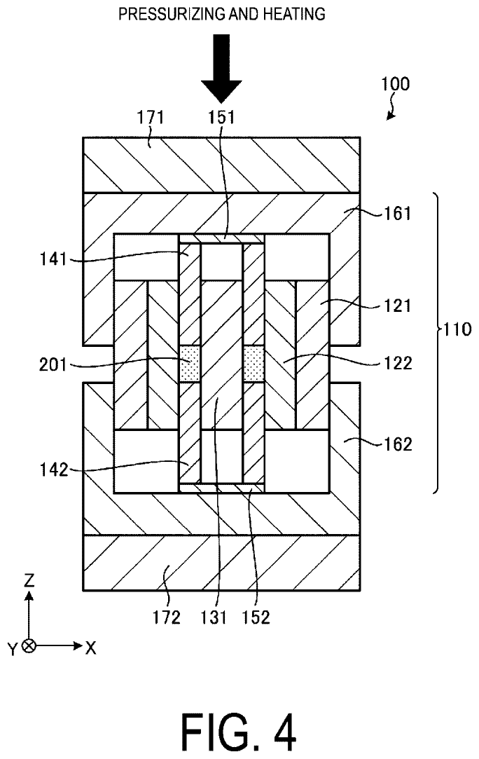

FIG. 4 is a cross-sectional view illustrating a state in which the mold 110 is set in the sintering apparatus 100. That is, the upper electrode 171 is disposed at the upper end of the upper die support 161, and the lower electrode 172 is disposed at the lower end of the lower die support 162. The upper electrode 171 and the lower electrode 172 are made of a conductive material (for example, graphite, cemented carbide, or the like). The sintering apparatus 100 includes a power supply device that supplies a predetermined current by applying a predetermined voltage between the upper electrode 171 and the lower electrode 172 and a control device. Although a spark plasma sintering apparatus (SPS apparatus) is used as the sintering apparatus 100, in the present embodiment, spark plasma sintering is not performed on the magnet powder, but sintering is performed only by Joule heat. Sintering is preferably carried out under reduced pressure or in an inert atmosphere such as an atmosphere of nitrogen or argon.

In FIG. 4, the rare earth iron-based magnet powder 201 filled in the cavity of the mold 110 is pressurized by the upper punch 141 and the lower punch 142 by the pressure applied between the upper electrode 171 and the lower electrode 172. In addition, the rare earth iron-based magnet powder 201 is heated by Joule heat generated by a current flowing through a path of the upper electrode 171→the upper die support 161→the outer die 121→the lower die support 162→the lower electrode 172. For example, the rare earth iron-based magnet powder is heated to a temperature from 600° C. to 700° C. while being pressurized at a pressure ranging from 30 MPa to 50 MPa.

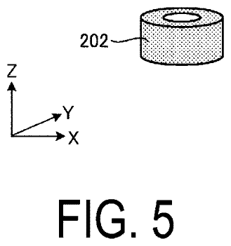

After heating, the current is switched off and cooling takes place. After cooling to a predetermined temperature, the mold 110 is removed from the sintering apparatus 100, and a sintered magnet body 202, the sintered magnet body being ring-shaped and formed by sintering the rare earth iron-based magnet powder 201, is removed from the mold 110. FIG. 5 is a perspective view of the sintered magnet body 202.

In the conventional spark plasma sintering apparatus as described in the above-mentioned JP 4-96203 A, since the rare earth iron-based magnet powder serves as an energizing path, the rare earth iron-based magnet powder is heated by spark plasma and Joule heat. In contrast, in the present embodiment, the rare earth iron-based magnet powder 201 does not serve as an energizing path, and is heated only by Joule heat from an energizing region. The upper punch 141, the lower punch 142, and the core 131 in contact with the rare earth iron-based magnet powder 201 are insulated by the upper insulating plate 151, the lower insulating plate 152, and the inner die 122, the inner die 122 being a non-conductive material (insulating material), and thus are not in direct contact with an energizing path. Therefore, in the present embodiment, the formation of coarse grains generated by spark plasma between the rare earth iron-based magnet powders in the permanent magnet is suppressed, and, consequently, an improvement in the magnetic characteristics can be expected. In addition, as mechanisms for sintering simply by heating, there are atmospheric heating and high-frequency heating, but since a wide area is heated, the efficiency is not good, and since heating is performed over a long period of time, coarse grains are likely to be formed, and thus the apparatus configuration of the present embodiment is more advantageous.

Next, referring back to FIG. 1, the operator or the control device forms an anti-corrosion treatment film on the sintered magnet body 202 taken out from the mold 110, as necessary (step S4).

Next, the operator or the control device magnetizes the sintered magnet body 202 (step S5). That is, the operator or the control device magnetizes the sintered magnet body 202 with a predetermined number of poles by using a magnetizing device (not illustrated) to obtain a rare earth-sintered magnet.

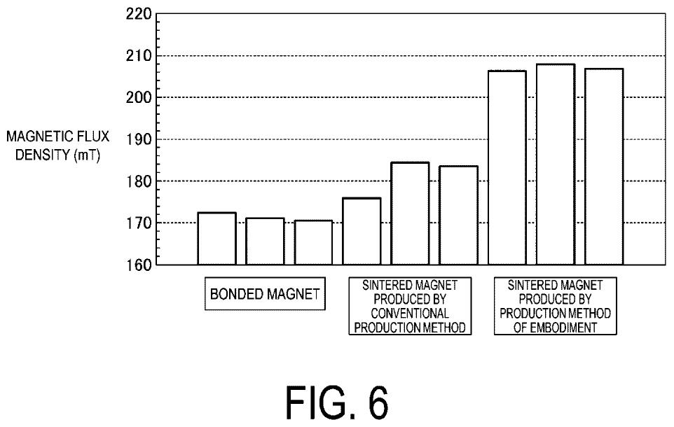

FIG. 6 is a diagram illustrating examples of measurement results of surface magnetic flux densities of a bonded magnet, a sintered magnet produced by a conventional production method, and a sintered magnet produced by the production method of the embodiment. In each case, the average of the local maximum values of the surface magnetic flux density is calculated for the case of the ring-shaped magnet being magnetized with 10 poles. Three samples were evaluated for each of the conventional production method, the production method of the present embodiment, and the bonded magnet. Surface magnetic flux was measured using a 50 μm square Hall device with the distance between the magnets and the Hall device fixed at 0.14 mm. The shape of the ring-shaped magnets is 1.6 mm (outside diameter)×0.6 mm (inside diameter)×3.5 mm (height). The density (g/cm³) of each magnet is about 6.0 (g/cm³) for the bonded magnet, about 7.5 (g/cm³) for the sintered magnet produced by the conventional production method, and about 7.5 (g/cm³) for the sintered magnet produced by the production method of the present embodiment.

As is apparent from FIG. 6, the value of the surface magnetic flux density of the rare earth iron-based sintered magnet produced by the conventional production method is only about 6% higher than that of the bonded magnet, whereas the value of the surface magnetic flux density of the rare earth iron-based sintered magnet produced by the production method of the present embodiment is about 20% higher than that of the bonded magnet, as expected from the density ratio.

When the volume ratio of coarse grains after sintering is 0 vol %, the ratio of increase in the magnet density and the ratio of increase in the surface magnetic flux density are the same. Therefore, the difference between the measured surface magnetic flux density after sintering and the theoretical value was defined as the amount of coarse grains (vol %), and the amount of coarse grains was calculated for each production method. Here, coarse grains are components not contributing to the surface magnetic flux density. The coarse grains, in terms of volume ratio, are 0% in the bonded magnet, from 13% to 17% in the sintered magnet produced by the conventional production method, and 2% or less in the sintered magnet produced by the production method of the present embodiment. Since the weight of a motor using a permanent magnet increases as the density of the permanent magnet increases, the smaller the amount of coarse grains that do not contribute to increasing the magnetic force of the permanent magnet, the more desirable it is for motor characteristics. Therefore, from the viewpoint of improving the motor characteristics and increasing the weight, the volume ratio of the coarse grains is preferably suppressed to 10% or less, and more preferably suppressed to 5% or less.

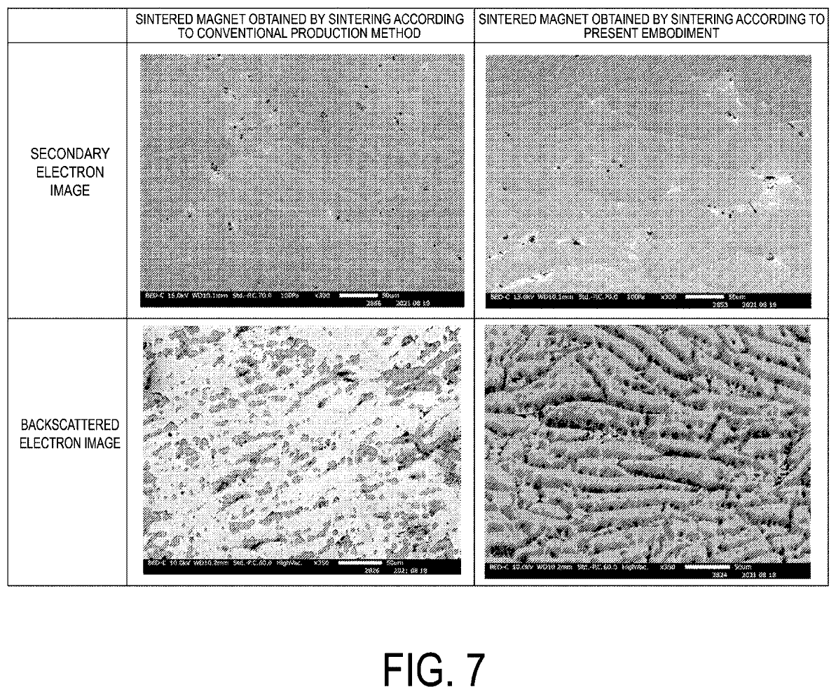

FIG. 7 shows the crystal structures of a sintered magnet according to a conventional production method and a sintered magnet according to the production method of the embodiment observed by using an electron microscope. As shown in FIG. 7, in the crystal structure of the rare earth iron-based sintered magnet produced by the conventional production method, the interface between the rare earth iron-based magnet powders is unclear, the formation of coarse grains is observed, and evidence of the influence of the spark plasma is observed. On the other hand, in the crystal structure of the rare earth iron-based sintered magnet according to the production method of the present embodiment, since the interface of the rare earth iron-based magnet powders was clear, the formation of coarse grains was not observed, and little evidence of the influence of energization was observed.

Although the case where the ring-shaped sintered magnet body 202 is obtained has been described, the sintered magnet body may have a disc shape. In this case, in FIGS. 2 to 4, for example, the core 131 is no longer necessary, and the upper punch 141 and the lower punch 142 have a columnar form.

Further, the upper punch 141 and the lower punch 142 may be made of the same non-conductive material as the inner die 122. In this case, the upper insulating plate 151 and the lower insulating plate 152 interposed between the upper punch 141 and the upper die support 161 and between the lower punch 142 and the lower die support 162 are not required. As the non-conductive material used for the upper punch 141 and the lower punch 142, the material is limited from the viewpoint of strength and thermal expansion coefficient. Therefore, from the viewpoint of strength and thermal expansion coefficient, it is preferable to use a cemented carbide, the cemented carbide being a conductive material.

The embodiments of the disclosure are described above; however, the disclosure is not limited to the above-mentioned embodiments and may be modified in various ways without departing from the gist of the disclosure.

As described above, a method for producing a rare earth iron-based sintered magnet according to an embodiment includes: a step of filling a mold with a rare earth iron-based magnet powder produced by a rapid quenching method; a step of setting the mold in a sintering apparatus, supplying a predetermined current from electrodes, and pressurizing and heating the rare earth iron-based magnet powder filled to produce a sintered magnet body; and a step of magnetizing the sintered magnet body with a magnetizing device. The mold includes dies having a hollow cylindrical form, punches to be inserted into the dies, and die supports made of a conductive material and disposed at respective both ends of the dies in an axial direction. A cavity to be formed by the dies and the punches is filled with the rare earth iron-based magnet powder. The dies include an inner die made of a non-conductive material and an outer die made of a conductive material and disposed outside the inner die, inner peripheral surfaces of the die supports are in contact with an outer peripheral surface of the outer die, and electrodes are in contact with the die supports. As a result, the formation of coarse grains at the interface between the rare earth-based magnet powders in the permanent magnet is suppressed, whereby the magnetic characteristics can be improved.

Insulating plates are interposed between the punches and the die supports. As a result, even when the punches are made of a conductive material, it is possible to have a configuration including punches not serving as an energizing path.

The electrodes, the die supports, and the outer die form an energizing path for the current supplied to the electrodes. As a result, it is possible to ensure prevention of formation of coarse grains due to spark plasma in the rare earth iron-based magnet powder.

An apparatus for producing a rare earth iron-based sintered magnet according to an embodiment includes a mold, a sintering apparatus, and a magnetizing device. The mold includes dies having a hollow cylindrical form, punches to be inserted into the dies, and die supports made of a conductive material and disposed at respective both ends of the dies in an axial direction. A cavity to be formed by the dies and the punches is filled with rare earth iron-based magnet powder produced by a rapid quenching method. The dies include an inner die made of a non-conductive material and an outer die made of a conductive material and disposed outside the inner die. Inner peripheral surfaces of the die supports come into contact with an outer peripheral surface of the outer die. Electrodes of the sintering apparatus are in contact with the die supports of the mold set in the sintering apparatus, a predetermined current is supplied from the electrodes, and the rare earth iron-based magnet powder is pressurized and heated to produce a sintered magnet body. The sintered magnet body is magnetized with the magnetizing device. Thus, an apparatus for producing a rare earth iron-based sintered magnet is provided.

The rare earth iron-based sintered magnet may have a volume ratio of coarse grains in the sintered magnet of 10% or less. Thereby, a magnet capable of being used at a high temperature and having excellent magnetic characteristics is obtained.

The disclosure is not limited to the embodiments described above. A configuration obtained by appropriately combining the above-mentioned components is also included in the disclosure. Further effects and modification examples can be easily derived by a person skilled in the art. Thus, a wide range of aspects of the disclosure is not limited to the embodiment described above and may be modified variously.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A method for producing a rare earth iron-based sintered magnet, the method comprising:
filling a mold with a rare earth iron-based magnet powder produced by a rapid quenching method;
setting the mold in a sintering apparatus, supplying a predetermined current from electrodes, and pressurizing and heating the rare earth iron-based magnet powder filled to produce a sintered magnet body; and
magnetizing the sintered magnet body with a magnetizing device, wherein
the mold includes dies having a hollow cylindrical form, punches to be inserted into the dies, and die supports made of a conductive material and disposed at respective both ends of the dies in an axial direction,
a cavity to be formed by the dies and the punches is filled with the rare earth iron-based magnet powder,
the dies include an inner die made of a non-conductive material and an outer die made of a conductive material and disposed outside the inner die,
inner peripheral surfaces of the die supports are in contact with an outer peripheral surface of the outer die, and
the electrodes are in contact with the die supports.

2. The method for producing a rare earth iron-based sintered magnet according to claim 1, wherein
insulating plates are interposed between the punches and the die supports.

3. The method for producing a rare earth iron-based sintered magnet according to claim 1, wherein
the electrodes, the die supports, and the outer die form an energizing path for the current supplied to the electrodes.

4. An apparatus for producing a rare earth iron-based sintered magnet, the apparatus comprising:
a mold;
a sintering apparatus; and
a magnetizing device, wherein
the mold includes dies having a hollow cylindrical form, punches to be inserted into the dies, and die supports made of a conductive material and disposed at respective both ends of the dies in an axial direction,
a cavity to be formed by the dies and the punches is filled with a rare earth iron-based magnet powder produced by a rapid quenching method,
the dies include an inner die made of a non-conductive material and an outer die made of a conductive material and disposed outside the inner die,
inner peripheral surfaces of the die supports are in contact with an outer peripheral surface of the outer die,
electrodes of the sintering apparatus are in contact with the die supports of the mold set in the sintering apparatus, a predetermined current is supplied from the electrodes, and the rare earth iron-based magnet powder is pressurized and heated to produce a sintered magnet body, and
the sintered magnet body is magnetized with the magnetizing device.

5. A rare earth iron-based sintered magnet, wherein
a volume ratio of coarse grains in the sintered magnet is 10% or less.
